(19) United States
(12) Patent Application Publication
(10) Pub. No.: US 2012/0220318 A1
(43) Pub. Date: Aug. 30, 2012

(54) CORDLESS TELEPHONE SYSTEM

(75) Inventors: JIAN LIU, Shenzhen City (CN); PING-CHOU CHEN, Tu-Cheng (TW); JIU-CHENG PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/110,888

(22) Filed: May 18, 2011

(30) Foreign Application Priority Data
Feb. 28, 2011 (CN) 201110047853.7

(51) Int. Cl. H04W 4/00

(52) U.S. Cl. 455/462

(57) ABSTRACT

A cordless telephone which includes a base station having a first phone-line interface and a first wireless transmitter/receiver, wherein the base station is connected to telephone network through the first phone-line interface. The cordless telephone further includes a handset having a second wireless transmitter/receiver communicating with the first wireless transmitter/receiver of the base station. The handset further includes a second phone-line interface capable of connecting to telephone network to allow the handset to communicate with the telephone network without the base station. Therefore, the user can still use the cordless telephone when the base station is unavailable due to power failure or malfunction.

### BACKGROUND

1. Technical Field

The present disclosure relates to a telephone system, and particularly, to a cordless telephone system.

2. Description of Related Art

A cordless telephone has a base station connecting to a fixed telephone line through a phone-line, communicating with a handset through wireless connection; therefore, users can talk on the phone with the handset and move freely within the wireless range. However, a major drawback of the cordless telephone is the requirement of an external power supply since transmitting wireless signals consumes high power; the cordless telephone is disabled when the external power is cut off, which always happens when there is a power failure, causing the cordless telephone to be useless while the conventional corded telephone can still function.

Therefore, what is needed is a cordless telephone system which can overcome the above listed limitations.

### BRIEF DESCRIPTION OF THE DRAWINGS

The components in the drawings are not necessarily drawn to scale, the emphasis instead being placed upon clearly illustrating the principles of cordless telephone system. Moreover, in the drawings, like reference numerals designate corresponding parts throughout the several views.

FIG. 1 is a schematic diagram of a cordless telephone system in accordance with one exemplary embodiment.

FIG. 2 is a schematic diagram of a cordless telephone system in accordance with another exemplary embodiment.

FIG. 3 is a block diagram of a cordless telephone system in accordance with one exemplary embodiment.

### DETAILED DESCRIPTION

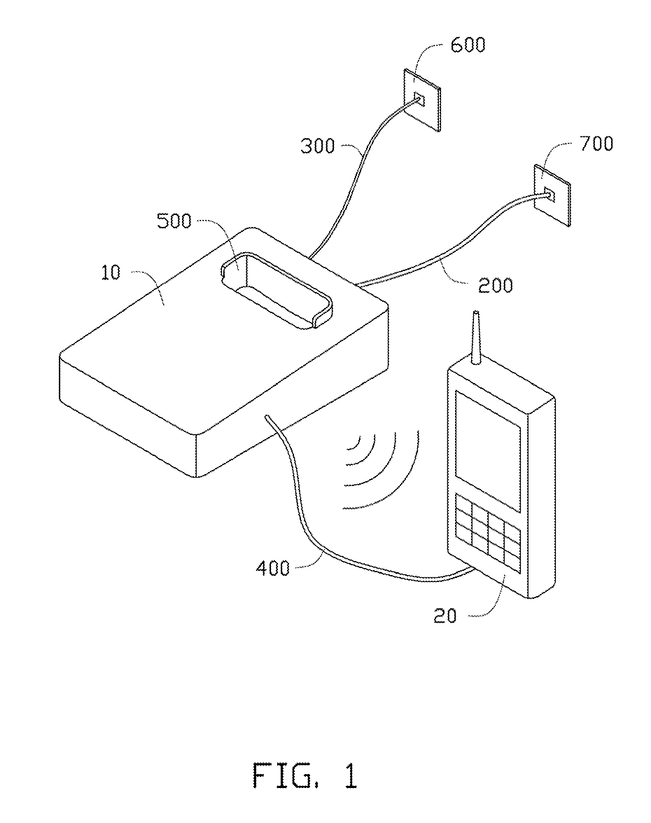

Referring to FIG. 1, a cordless telephone system has a base station 10 and a handset 20, wherein the base station 10 is connected to household power outlet 600 through a power line 300; the base station 10 is further connected to a fixed telephone line 700 through a phone-line 200. The handset 20 can establish a wireless connection with the base station 10 to allow users to talk on the phone freely within the range of the wireless connection. When power failure occurs, the handset 20 can connect to the base station 10 through a phone wire 400 or a contact (not shown) in a cradle 500 of the base 10 rather than the wireless connection; therefore, the cordless telephone system can still be functional when the household power 600 is cut off, just like a conventional corded telephone.

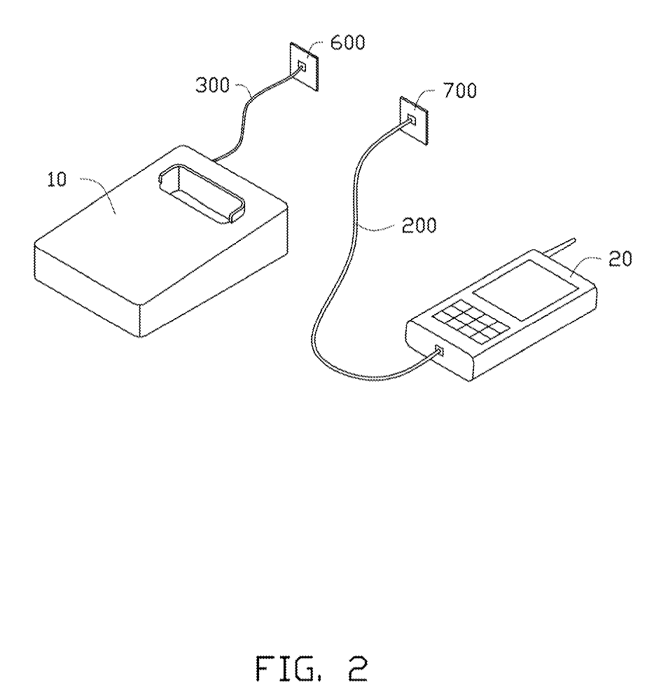

Referring to FIG. 2, in another embodiment, the handset 20 can be connected to the fixed telephone line 700 through the phone-line 200; therefore, when the base station 10 is unavailable due to power failure or malfunction, the handset 20 can act as a telephone in independent of the base station 10.

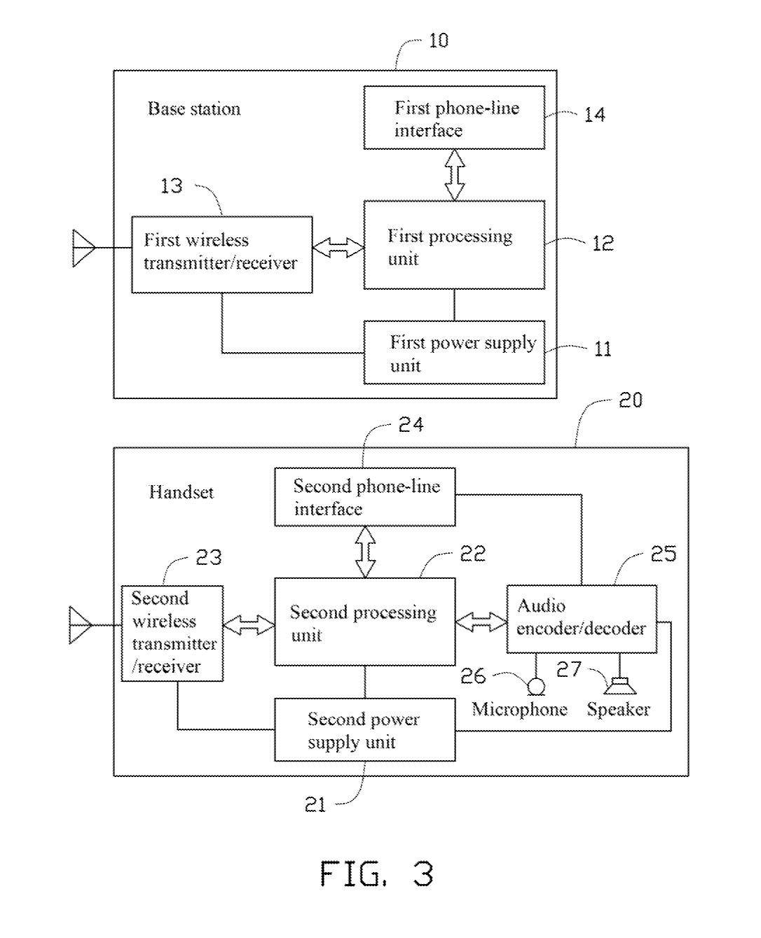

Referring to FIG. 3, the base station 10 includes a first power supply unit 11 connected with the household power 600 which supplies power to a first processing unit 12 and a first wireless transmitter/receiver 13 through the first power supply unit 11. The first processing unit 12 is connected with a first phone-line interface 14 connecting with the fixed telephone line 700, and transmits electrical signals from the first phone-line interface 14 to the first wireless transmitter/receiver 13 to broadcast the electrical signals.

The handset 20 includes a second power supply unit 21 to supply power to a second wireless transmitter/receiver 23, a second processing unit 22, and an audio encoder/decoder 25 connected with a microphone 26 and a speaker 27. The second wireless transmitter/receiver 23 communicates with the first wireless transmitter/receiver 13 of the base station 10 to transmit and receive the electrical signals; the second wireless transmitter/receiver 23 further transmits electrical signals between the audio encoder/decoder 25 and the second wireless transmitter/receiver 23; the audio encoder/decoder 25 converts the electrical signals into sound waves, or vice versa.

In the present embodiment, the handset 20 further includes a second phone-line interface 21 capable of connecting the fixed telephone line 700 to act like an independent telephone. The processing unit 22 monitors the communication between the second wireless transmitter/receiver 23 and the first wireless transmitter/receiver 13; when the second wireless transmitter/receiver 23 is unable to communicate with the first wireless transmitter/receiver 13, the second processing unit 22 generates alert signals like beeping or flashing to notify the users, and initiates the phone-line interface 21 for connecting with the fixed telephone line 700.

In another embodiment, the second phone-line interface 21 is connected to the fixed telephone line 700 through the first phone-line interface 21 to allow the cordless telephone system to act like a conventional corded telephone without wireless connection.

Therefore, the user can use the cordless telephone system as a cordless telephone when powered by the household power 600 and as a conventional corded telephone if the household power 600 is cut off or the base station 10 is unavailable.

1. A cordless telephone system, comprising:
a base station comprising a first phone-line interface and a first wireless transmitter/receiver, wherein the base station is connected to a telephone network through the first phone-line interface through a first phone wire;
a handset comprising a second wireless transmitter/receiver to communicate with the first wireless transmitter/receiver of the base station; the handset further comprising a second phone-line interface capable of connecting to the telephone network to allow the handset to communicate with the telephone network through the first phone wire without using the second wireless transmitter/receiver.

2. The cordless telephone system as claimed in claim 1, wherein the base station further comprises a first power supply unit and a first processing unit, the first power supply unit is for being connected to an external power supply to power the first wireless transmitter/receiver and the first processing unit; and the first processing unit is capable of transmitting electrical signals between the first phone-line interface and the first wireless transmitter/receiver.

3. The cordless telephone system as claimed in claim 1, wherein the handset further comprises a second power supply unit, a second processing unit, and an audio encoder/decoder, the second power supply unit provides power to the second processing unit and the audio encoder/decoder; the second processing unit is capable of transmitting electrical signals between the second wireless transmitter/receiver and the audio encoder/decoder when the second wireless transmitter/receiver communicates with the first wireless transmitter/receiver of the base station.

4. The cordless telephone system as claimed in claim 3, wherein the second processing unit is capable of transmitting electrical signals between the second phone-line interface and the audio encoder/decoder when the second phone-line interface is connected to the telephone network.

5. The cordless telephone system as claimed in claim 1, wherein the second phone-line interface is connected to the telephone network directly through the first phone wire or is connected to the first phone-line interface of the base through a second phone wire to communicate with the telephone network.

6. The cordless telephone system as claimed in claim 3, wherein the second processing unit generates a alert signal when the second wireless transmitter/receiver is unable to communicate with the first wireless transmitter/receiver, and initiates the second phone-line interface to connect to telephone network.

7. The cordless telephone system as claimed in claim 6, wherein the alert signal is an audible signal or a visual signal.
